(19) United States
(12) Patent Application Publication
(10) Pub. No.: US 2014/0324755 A1
(43) Pub. Date: Oct. 30, 2014

(54) INFORMATION PROCESSING APPARATUS AND CONTROL METHOD THEREOF

(71) Applicant: SAMSUNG ELECTRONICS CO., LTD., Suwon-si (KR)

(72) Inventors: Dong-min PARK, Gwacheon-si (KR); Jong-ho LEA, Seongnam-si (KR); Sung-hun CHOI, Suwon-si (KR)

(73) Assignee: SAMSUNG ELECTRONICS CO., LTD., Suwon-si (KR)

(21) Appl. No.: 14/261,915

(22) Filed: Apr. 25, 2014

(30) Foreign Application Priority Data
Apr. 26, 2013 (KR) 10-2013-0046478

(51) Int. Cl. G06N 5/02

(52) U.S. Cl. CPC G06N 5/02
USPC 706/47

(57) ABSTRACT

An information processing apparatus includes: an event detection unit to detect occurrence of an event; an event information collection unit to collect information about the event detected by the event detection unit; a rule database to store a rule that defines a condition of a state of the information processing apparatus and an action performed on the information processing apparatus when the condition is satisfied; a rule based processing unit to select at least one rule to be applied to the event from the rule database based on at least part of the information collected by the event information collection unit, and to perform a rule based process of processing the event based on the selected rule; and a final event transfer unit to transfer the processed event to a predetermined final event handler of the information processing apparatus so as to perform a preset operation corresponding to the event.

### CROSS-REFERENCE TO RELATED APPLICATION

This application claims priority from Korean Patent Application No. 10-2013-0046478, filed on Apr. 26, 2013 in the Korean Intellectual Property Office, the disclosure of which is incorporated herein by reference in its entirety.

### BACKGROUND

1. Field

Apparatuses and methods consistent with the exemplary embodiments relate to an information processing apparatus capable of processing various types of information and a control method thereof, and more particularly to an information processing apparatus having an improved structure to facilitate an event processing procedure in detecting an event occurring and processing the event to perform an action corresponding to the detected event, and a control method thereof.

2. Description of the Related Art

An information processing apparatus refers to any device capable of processing various forms of information or data according to a predetermined process to perform different actions based on processing results. A trigger for the information processing apparatus to perform a specific action and a collection of data which defines or is indicative of a trigger are each referred to as an event. When an occurrence of an event is detected, the information processing apparatus analyzes and processes the event, thereby determining and performing a corresponding action.

The event may occur outside the information processing apparatus, for example, a user input, or occur inside the information processing apparatus, for example, a timeout according to a clock count. As models of events grow more diverse, the information processing apparatus tends to have a gradually complicated structure of processing the events.

A conventional information processing apparatus for event processing may have difficulty in deriving an optimal action for circumstances during a procedure of processing the event and also involve code correction and compiling of a handler that performs an action depending on an event. However, the handler may be configured as an application implemented on an operating system, while code correction of the handler may not be easy depending on a structure.

Thus, an information processing apparatus capable of easily processing and efficiently configuring and managing a complicated event may be needed.

### SUMMARY

The foregoing and/or other aspects may be achieved by providing an information processing apparatus including: an event detection unit to detect occurrence of an event; an event information collection unit to collect information about the event detected by the event detection unit; a rule database to store a rule that defines a condition of a state of the information processing apparatus and an action performed on the information processing apparatus when the condition is satisfied; a rule based processing unit to select at least one rule to be applied to the event from the rule database based on at least part of the information collected by the event information collection unit, and to perform a rule based process of processing the event based on the selected rule; and a final event transfer unit to transfer the processed event to a predetermined final event handler of the information processing apparatus so as to perform a preset operation corresponding to the event.

The rule based processing unit may select the rule having the condition corresponding to at least part of the information about the event from the rule database.

The information about the event may include at least a kind of the event.

The information processing apparatus may further include an event information storage unit to store the event and the information about the event, wherein the rule based processing unit may invoke and process the event stored in the event information storage unit according to a preset order.

The preset order may be an order in which a plurality of events is stored in the event information storage unit.

The events may be allocated priority based on the information about the event stored in the event information storage unit, and the rule based processing unit may invoke and process the events from the event information storage unit according to the priority.

The information processing apparatus may further include a rule processing determination unit to determine based on a preset condition whether to transmit the event detected by the event detection unit to the rule based processing unit so as to perform the rule based process or to transmit the event to the final event transfer unit, bypassing the rule based processing unit, so as not to perform the rule based process.

The rule processing determination unit may determine a transfer direction of the event based on the information about the event by the event information collection unit.

The final event handler may include an application implemented on an operating system of the information processing apparatus.

The information processing apparatus further include a user input unit to receive a user input, wherein the event detection unit may detect the event of user input through the user input unit.

The foregoing and/or other aspects may be achieved by providing a control method of an information processing apparatus, the control method including: detecting occurrence of an event; collecting information about the event; selecting at least one rule to be applied to the event from a rule database based on at least part of the information about the event, the rule database storing a rule that defines a condition of a state of the information processing apparatus and an action performed on the information processing apparatus when the condition is satisfied; performing a rule based process by processing the event based on the selected rule; and transferring the processed event to a predetermined final event handler of the information processing apparatus so as to perform a preset operation corresponding to the event.

The selecting of the at least one rule may include selecting the rule having the condition corresponding to at least part of the information about the event from the rule database.

The information about the event may include at least a kind of the event.

The collecting of the information about the event may include determining based on a preset condition at least one of to perform the rule based process on the event and not to perform the rule based process on the event by transmitting the event to the final event transfer unit.

The determining based on the preset condition may include determining a transfer direction of the event based on the information about the event.

The final event handler may include an application implemented on an operating system of the information processing apparatus.

The event may occur by a user manipulation.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram illustrating a configuration of an information processing apparatus according to a first exemplary embodiment.

FIG. 2 is a diagram illustrating a configuration of a signal processing unit to perform an action corresponding to an event in the information processing apparatus of FIG. 1.

FIG. 3 is a flowchart illustrating a pre-processing procedure performed by the signal processing unit of FIG. 2.

FIG. 4 is a flowchart illustrating a rule based process performed by the signal processing unit of FIG. 2.

FIG. 5 illustrates a method of a rule based processing unit of FIG. 2 processing an event based on a rule.

FIG. 6 illustrates a form of storing an event in an event information storage unit of FIG. 2.

FIG. 7 illustrates a form of invoking an event stored in the event information storage unit of FIG. 2.

FIG. 8 illustrates a process that the rule based processing unit of FIG. 2 changes a logical processing state of an event.

FIG. 9 is a diagram illustrating a configuration of a signal processing unit to perform an action corresponding to an event according to a second exemplary embodiment.

### DETAILED DESCRIPTION OF EXEMPLARY EMBODIMENTS

Below, exemplary embodiments will be described in detail with reference to accompanying drawings so as to be easily realized by a person having ordinary skill in the art. The exemplary embodiments may be embodied in various forms without being limited to the exemplary embodiments set forth herein. Descriptions of well-known parts are omitted for clarity and conciseness, and like reference numerals refer to like elements throughout.

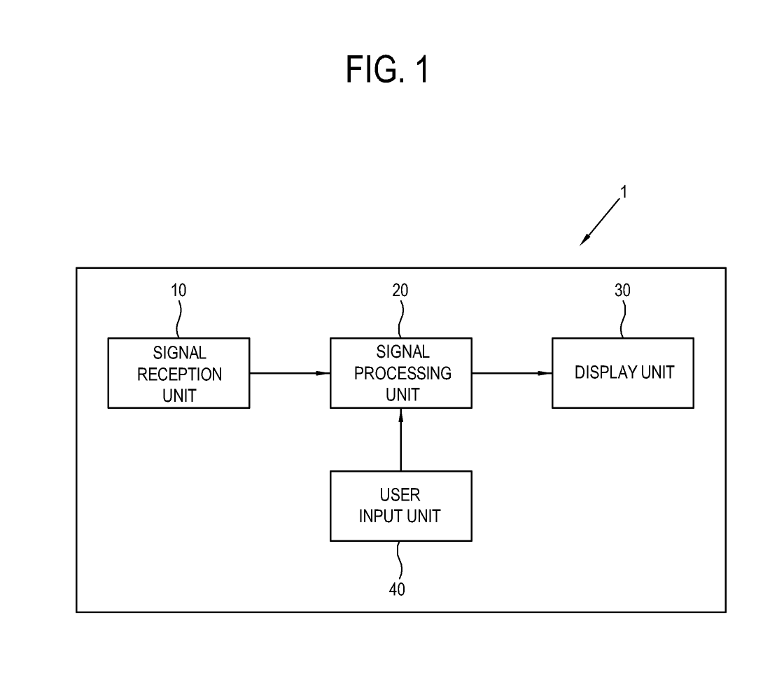

FIG. 1 is a block diagram illustrating a configuration of an information processing apparatus 1 according to a first exemplary embodiment. Although the information processing apparatus 1 is configured as a display apparatus, such as a television (TV), in the present embodiment, various types of electronic devices, such as a computer and a mobile phone, may be employed as the information processing apparatus 1.

As shown in FIG. 1, the information processing apparatus 1 includes a signal reception unit 10 to receive a signal from the outside, a signal processing unit 20 to process the signal received by the signal reception unit 10, a display unit 30 to display an image based on a signal processing result by the signal processing unit, and a user input unit 40, i.e. a user input apparatus, to control a processing operation of the signal processing unit 20 based on a user input.

The signal reception unit 10 is various forms of wire-based/wireless interfaces to enable the information processing apparatus 1 to communicate with the outside. The signal reception unit 10 connects to a wide area network or local area network to conduct two-way communications with an external device (not shown) including a server (not shown) or connects to the external device through a cable to receive signals/data/information from the external device.

The signal processing unit 20 processes data received through the signal reception unit 10 or previously stored in the information processing apparatus 1 according to a preset process. The signal processing unit 20 may be configured as an integrated multi-functional component, such as a system on chip (SOC), or as a processing board (not shown) formed by mounting components which independently conduct individual processes on a printed circuit board and embedded in the information processing apparatus 1.

According to an illustrative operation method of the signal processing unit 20, the signal processing unit 20 processes an application to be implemented on an operating system, which is running, and outputs relevant data to the display unit 30 so that an image of the application is displayed on the display unit 30.

The display unit 30 displays an image based on an image signal/image data output from the signal processing unit 20. The display unit 30 may be configured in various display modes using liquid crystals, plasma, light emitting diodes, organic light emitting diodes, a surface conduction electron emitter, a carbon nano-tube, nano-crystals, or the like, without being limited thereto.

The display unit 30 may further include an additional element according to a configuration of a panel. For example, when the display unit 30 has a liquid crystal display (LCD) panel, the display unit 30 may include a backlight unit (not shown) to provide light to the LCD panel and a panel drive board (not shown) to drive the panel. Alternatively, when the display unit 30 has a self-emitting panel, the display unit 30 does not include a backlight unit to provide light to the panel.

The user input unit 40 is manipulated by a user to transmit a command based on a user intent to the signal processing unit 20. For example, the user input unit 40 may be configured as a key/button unit or a touchpad manipulated by the user, or a sensing unit to detect motions and voices of the user.

Here, in a case where a user manipulates the user input unit 40 to control an operation of an application being implemented on the information processing apparatus 1, the signal processing unit 20 processes the application to operate corresponding to a user input that occurs in the user input unit 40. Here, defining the user input as an event, and the operation of the application as an action, the signal processing unit 20 processes the event to perform the action corresponding to the event.

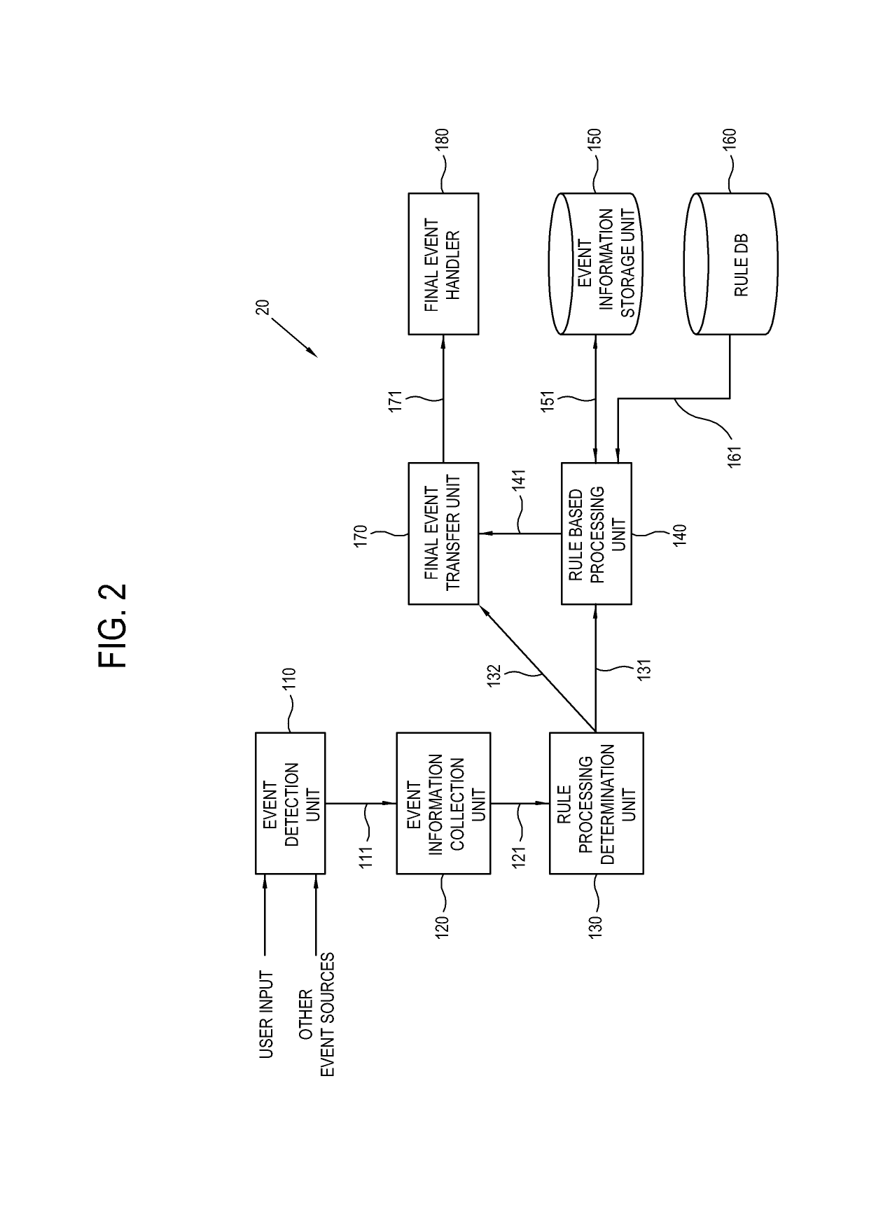

Hereinafter, a method of the signal processing unit 20 performing an action corresponding to an event will be described with reference to FIG. 2.

FIG. 2 is a diagram illustrating a configuration of the signal processing unit 20 to perform an action corresponding to an event.

As shown in FIG. 2, the signal processing unit 20 includes subcomponents, such as an event detection unit 110 i.e. an event detector, an event information collection unit 120 i.e. an event information collector, a rule processing determination unit 130 i.e. a rule processing decider, a rule based processing unit 140 i.e. a rule based processor, and a final event transfer unit 170 i.e. a final event transferor. These components may be configured as physical hardware forming the signal processing unit 20, software or program codes implemented in the signal processing unit 20, or a combination of hardware and software.

The event detection unit 110 detects an event that occurs in various forms from an event source. The event detected by the event detection unit 110 may occur through the user input unit 40 and from different event sources. When the event occurs through the user input unit 40, the event occurs via various types of user input units 40 interacting with a user, such as a keyboard, a mouse, a remote controller, a touch input unit, a gesture input unit and a microphone.

The different event sources may include a timer embedded in the information processing apparatus 1. The timer is a clock for indicating a specified time interval or elapsed time, which may be used to process a timeout at which an event or action is finished. Alternatively, the event sources may include software/applications implemented on the information processing apparatus 1. For instance, if recognition of a user voice is possible only when voice recognition software is activated, the voice recognition software may be the event source.

The event detection unit 110 detects any type of event that occurs by the user input or the event sources and transmits a detection result to the event information collection unit 120 (111). The event detection unit 110 may detect the event in various methods, for example, a falling method of continuously monitoring events occurring in the event sources or an interrupt method of being notified of occurrence of an event from a corresponding event source when the event occurs.

The event information collection unit 120 collects information needed to process the event detected by the event detection unit 110. The information collected by the event information collection unit 120 may vary on characteristics and kinds of events, for example including information on an event type. In addition, the event information collection unit 120 may collect various kinds of information, for example, event occurrence time, a user that caused an event and a condition of an event source when an event occurs. The event information collection unit 120 transmits the event and the collected information about the event to the rule processing determination unit 130 (121).

The rule processing determination unit 130 determines to where the event is transmitted based on the information collected by the event information collection unit 120. The rule processing determination unit 130 transmits the event to the rule based processing unit 140 (131) or to the final event transfer unit 170 (132) based on a determination result.

The rule processing determination unit 130 transmits the event to the rule based processing unit 140 and directly to the final event transfer unit 170 as necessary. The rule processing determination unit 130 may transmit the event straight to the final event transfer unit 170 when event processing performance takes precedence. For example, if it is needed to transfer an event to the final event handler 180 as quickly as possible, the event may bypass the rule based processing unit 140 to avoid a processing delay.

If the rule based processing unit 140 is designed to process all events, the rule processing determination unit 130 may be omitted and the event information collection unit 120 may transmit the events straight to the rule based processing unit 140.

The rule processing determination unit 130 may transmit the event to both the rule based processing unit 140 and the final event transfer unit 170, instead of to either of the rule based processing unit 140 and the final event transfer unit 170. In this instance, the event may be processed without a rule based process by the rule based processing unit 140 and be applied for reference for a rule based process of another event.

The rule based processing unit 140 processes the received event based on a rule and transmits a processing result to the final event transfer unit 170 (141). The rule is guidelines for processing an event, which basically include specified conditions and actions performed when the conditions are satisfied. Here, the rule applied to the event may be a rule having a condition corresponding to the collected information on the event selected among various preset rules.

The rule based processing unit 140 retrieves the rule corresponding to the event from a rule database (DB) 160 including a plurality of rules (161). The rule DB 160 may be configured as a binary code in view of optimal performance or as a text for readability of an administrator or ease of management. Further, the rules recorded in the rule DB 160 may be represented according to diverse forms of script grammar.

The rule based processing unit 140 extracts at least one event stored in an event information storage unit 150 (151) and processes the event based on a rule by repeating a process of applying at least one rule to the extracted event. Here, the rule based processing unit 140 stores the event received from the rule processing determination unit 130 first and extracts an event stored in the event information storage unit 150 according to preset processing order. Alternatively, the rule processing determination unit 130 immediately stores an event in the event information storage unit 150, and the rule based processing unit 140 extracts an event from the event information storage unit 150.

The rule based processing unit 140 may extract the event from the event information storage unit 150 in various methods. For example, the rule based processing unit 140 may extract an event according to storage order of events in the event information storage unit 150. Alternatively, an event is given priority when being stored in the event information storage unit 150, and accordingly the rule based processing unit 140 may extract an event from the event information storage unit 150 according to priority.

The rule based processing unit 140 enables implementation of various actions recorded in a rule invoked corresponding to an event. For example, the actions included in the rule may be provided to further collect additional information needed to process a corresponding event, to process a subordinate event at a past time point, to enable a future event to stand by for occurrence, to identify timing relationships between a plurality of events, or to retrieve particular types of events to integrate. In a simple event, the rule based processing unit 140 may instantly process the event, instead of transmitting the event to the final event transfer unit 170. For example, the rule based processing unit 140 may terminate an event considered unnecessary.

The event information storage unit 150 stores events that need processing by the rule based processing unit 140. The event information storage unit 150 may store events that have occurred or been processed from a preset time point to a present time. If an optimal action for circumstances and context is needed for a user input, the rule based processing unit 140 may need to integrate an event with a relevant event, instead of processing the single event. To this end, the event information storage unit 150 stores a plurality of events and transmits a stored event to the rule based processing unit 140 according to a request from the rule based processing unit 140. The event information storage unit 150 may include index information to enable quick retrieval of a particular event.

The final event transfer unit 170 invokes a final event handler 180 corresponding to the event provided from the rule processing determination unit 130 or the rule based processing unit 140 and transmits the event to the final event handler 180 (171). The final event handler 180 may be, for example, an application implemented on an operating system or a static program code that is not updatable.

Here, the final event transfer unit 170 invokes the final event handler 180 specified by the rule based processing unit 140 based on a rule based processing result. Alternatively, with different types of final event handlers 180 registered in the final event transfer unit 170, when an event processing method or type is specified by the rule based processing unit 140, the final event transfer unit 170 may invoke a proper final event handler 180 for the specified type.

In a conventional method, when an event occurs, the event is immediately transmitted to the final event handler 180 without a rule based process. In the present embodiment, however, the event is processed by the rule based processing unit 140 based on the rule and then transmitted to the final event handler 180, thereby implementing an optimized action without updating the final event handler 180.

Further, since the rule based process is performed in a middleware level lower than an application level, instead of in the application level, the embodiment may be easily applied to a feedback process between applications.

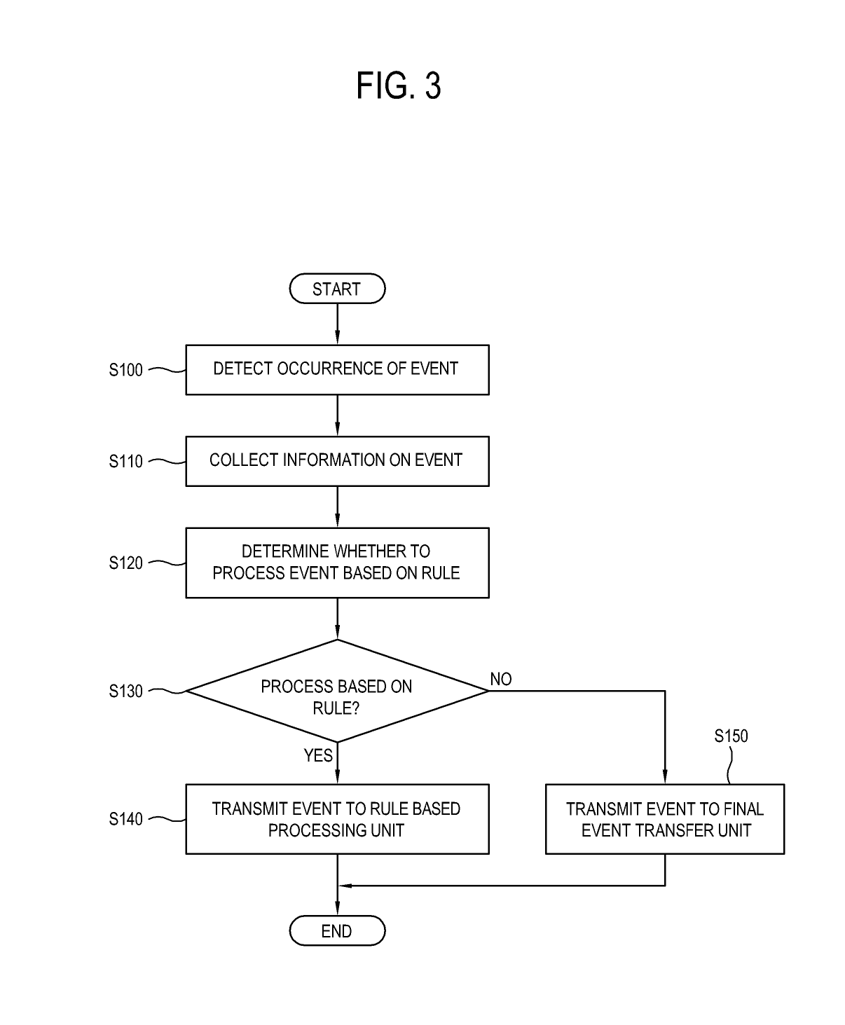

FIG. 3 is a flowchart illustrating a pre-processing procedure performed by the signal processing unit 20. The pre-processing procedure is performed by the event detection unit 110, the event information collection unit 120, and the rule processing determination unit 130.

As shown in FIG. 3, the event detection unit 110 detects that an event occurs (S100). The event information collection unit 120 collects information about the event (S110). The rule processing determination unit 130 determines whether to process the event based on a rule (S120).

When it is determined that the event is processed based on the rule (S130), the rule processing determination unit 130 transmits the event to the rule based processing unit 140 to perform the rule based process (S140). However, when it is determined that the event is not processed based on the rule, the rule processing determination unit 130 transmits the event to the final event transfer unit 170 to be processed by the final event handler 180 (S150).

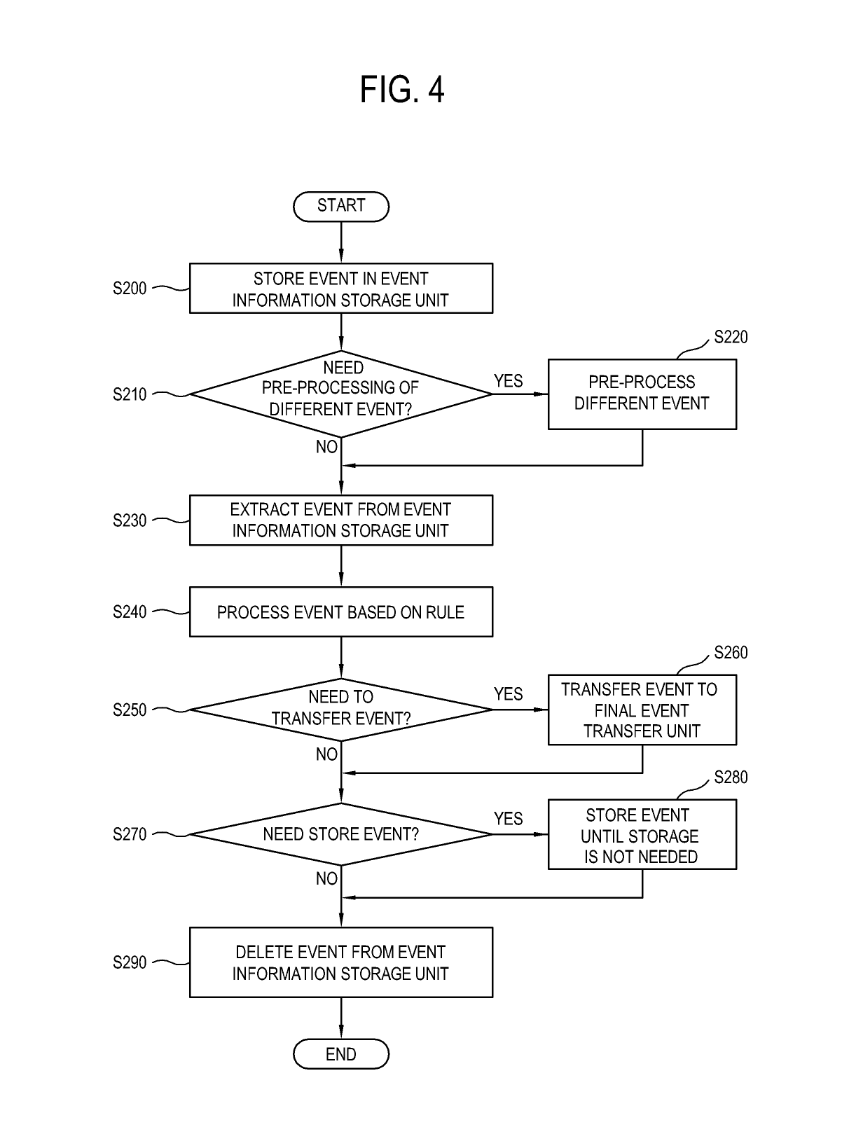

FIG. 4 is a flowchart illustrating a rule based process performed by the signal processing unit 20. The rule based process corresponds to the process carried out by the rule based processing unit 140 of FIG. 2.

As shown in FIG. 4, an event is stored in the event information storage unit 150 (S200), the rule based processing unit 140 determines whether a preconditioning process for a different event is needed (S210). When it is determined that the preconditioning process for the different event is needed, the rule based processing unit 140 preprocesses the different event (S220).

The rule based processing unit 140 extracts the event from the event information storage unit 150 (S230) and processes the event based on a rule (S240). When it is determined that the event needs transmitting (S250), the rule based processing unit 140 transmits the event to the final event transfer unit 170, so that the event is processed by the final event handler (S260).

The rule based processing unit 140 determines whether there is a need to store the event in the event information storage unit 150 (S270). When it is determined that the event needs storing, the rule based processing unit 140 stores the event in the event information storage unit 150 until storage of the event is not needed (S280). However, when it is determined that the event does not need storing, the rule based processing unit 140 deletes the event from the event information storage unit 150 (S290).

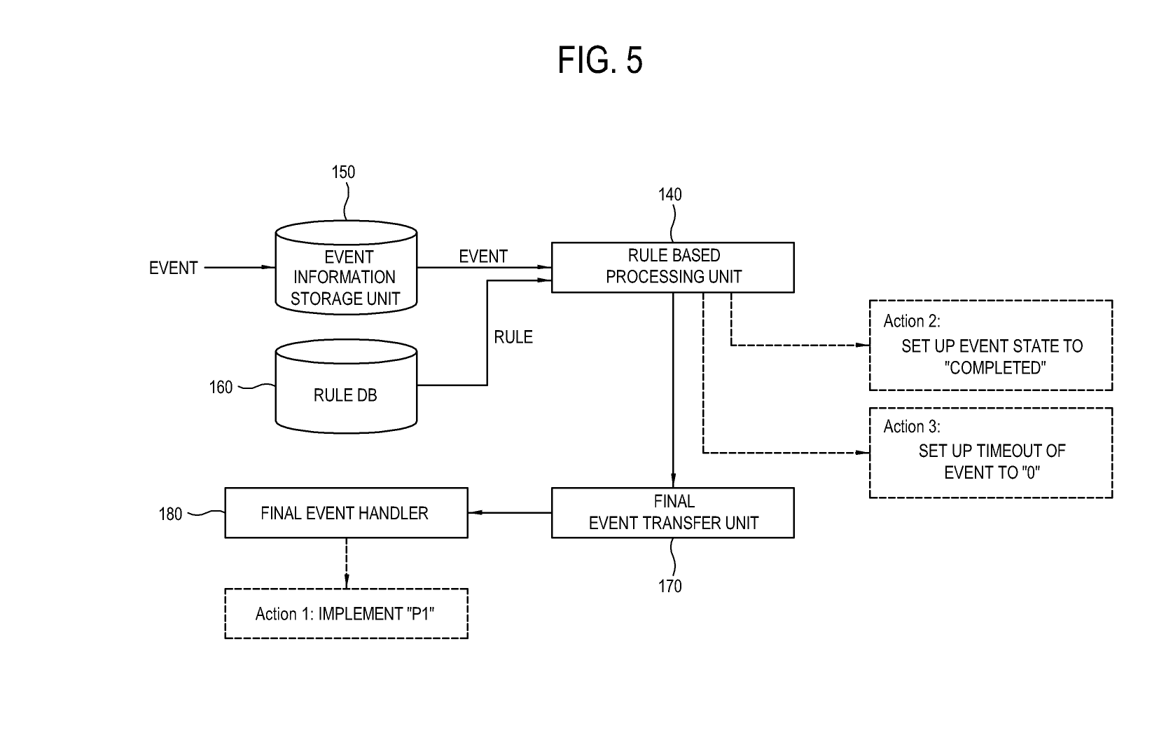

FIG. 5 illustrates a method of the rule based processing unit 140 processing an event based on a rule.

The rule based processing unit 140 invokes the event input from the event information storage unit 150 and retrieves the rule from the rule DB 160 based on the information about the event. The rule based processing unit 140 processes the event according to the actions recorded in the rule.

The rule based processing unit 140 transmits information to report that the final event handler 180 of “P1” needs implementing to the final event transfer unit 170, thereby performing a first action. The final event transfer unit 170 implements the final event handler 180 of “P1” according to a specification of the rule based processing unit 140.

The rule based processing unit 140 sets up the state of the event to “Completed” to perform a second action. Subsequently, the rule based processing unit 140 sets up the timeout of the event to 0 to perform a third action. In this case, the event passes valid time for processing and thus is not a processing object any more.

As a non-limiting example in an exemplary embodiment, when an event “Input a power button on a remote controller” occurs, the rule based processing unit 140 may select a rule including conditions “remote controller” and “power” from the rule DB 160. Here, the selected rule may include the following details according to script grammar.

```
<RuleCondition>
  <AND>
    <RelOp Var=“Type” Op=“Equal” Value=“RemoteCon”/>
    <RelOp Var=“Button” Op=“Equal” Value=“Power” />
  </AND>
</RuleCondition>
<RuleActions>
  <RunHandler Name=“P1” />
  <SetState State=“Completed” />
  <SetTimeout Timeout=“0”/>
</RuleActions>
```

The foregoing script grammar used for the rule is provided for illustrative purposes only, and the rule may be described in various ways and forms, without being limited thereto. Information between “<RuleCondition>” and “</RuleCondition>” is details about a condition, while information between “<RuleActions>” and “</RuleActions>” is details about actions.

In this rule, the condition denotes an input of “power button” on “remote controller.” The actions of the rule denotes invoking and implementing a final event handler with an identification (ID) of “P1,” setting up a state of the event to “Completed,” and setting up a timeout of the event to 0.

The rule may have various forms in addition to the script style, for example, in a text form in view of readability of an administrator or in a binary code in view of operation performance in the information processing apparatus 1. The rule may have various forms of grammar, without being particular, as long as it is divided into a condition and an action.

Hereinafter, uses of the information processing apparatus 1 according to the present embodiment are illustrated.

In a first example, suppose that a user says “What is this?” indicating any object in an image displayed on the information processing apparatus 1.

The information processing apparatus 1 may detect a voice instruction having content of “What is this?” through a voice recognition system and a location in the displayed image indicated by the user through a gesture recognition system. The information processing apparatus 1 comprehensively processes an event of the voice instruction and a location detection event based on a rule, thereby ultimately providing a user with descriptions about an object in the image. For example, defining the voice instruction having the content of “What is this?” as a first event and the user indicating the location in the image as a second event, the first event and the second event are interpreted into a new integrated event, and the integrated new event is transmitted to the relevant final event handler.

In this way, the information processing apparatus 1 may combine events respectively occurring through a plurality of installed input configurations, thereby performing one optimized action.

In a second example, suppose that a user performs a motion of pressing a volume up button on a remote controller simultaneously with saying “Volume up” with an image being displayed on the information processing apparatus 1.

An event of the motion of pressing the volume up button on the remote controller and an event of saying “Volume up” bring the same result. If a plurality of events bringing the same result occurs, the information processing apparatus 1 implements a result of only one event through a rule based process on each event. For example, the information processing apparatus 1 processes just the motion of pressing the volume up button on the remote controller through the rule based process and terminates the event of saying “Volume up” without processing the event.

Accordingly, malfunction of a user input and redundant implementation of the event may be prevented.

In a third example, with an image being displayed on the information processing apparatus 1, a first user watching the image says “Volume up” to control the information processing apparatus 1 in a first situation, while a second user not watching the image says “Volume down,” for example, so as to ask the first user to turn down the volume, not to control the information processing apparatus 1 in a second situation.

The information processing apparatus 1 may recognize faces and directions of the first user and the second user and detect voice instructions resulting from speeches of the respective users through a facial recognition system and a voice recognition system. The information processing apparatus 1 deduces that a user saying “Volume up” is the first user and the first user has an intent to control the information processing apparatus 1 in that the face of the first user faces the direction of the information processing apparatus 1 in the first situation, and accordingly implements the voice instruction of the first user. Meanwhile, the information processing apparatus 1 deduces that a user saying “Volume down” is the second user and the second user does not have an intent to control the information processing apparatus 1 in that the face of the second user faces in a different direction from the direction of the information processing apparatus 1 in the second situation, and accordingly does not implement the voice instruction of the second user.

In a conventional method which does not involve a rule based process, a user's action may be interpreted as an instruction to conduct the instruction regardless of whether the user has an intent to control the information processing apparatus 1. According to the present embodiment, the information processing apparatus 1 prevents malfunction of a user instruction and handles a situation of including a plurality of users to implement only an instruction of a user who wishes to control the information processing apparatus 1.

In a fourth example, suppose that an event is delayed substantially due to various reasons, for example, an error in an internal algorithm of the information processing apparatus 1.

The information processing apparatus 1 may set up a timeout of an event as a processing target to a variable value appropriate for circumstances of the event. Then, the information processing apparatus 1 checks the timeout, and processes the event if time elapses within the timeout. However, the information processing apparatus 1 deletes the event from the event information storage unit 150 if time elapses out of the timeout.

Accordingly, the information processing apparatus 1 processes the event within a user desired time, and the user may properly induce the event to occur again if there is a delay in processing the event.

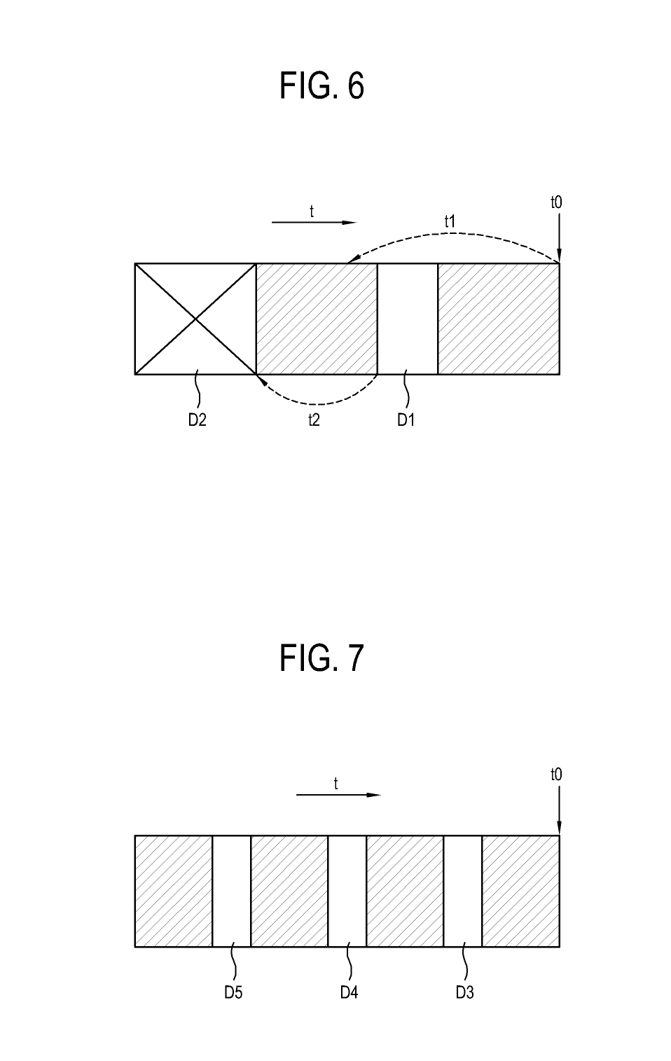

FIG. 6 illustrates a form of storing an event in the event information storage unit 150.

As shown in FIG. 6, in storing an event in the event information storage unit 150, events that have occurred before a present time t0 are accumulatively stored. That is, as t represents time, events positioned at a left side based on the rightmost time t0 occurred in the past.

The event information storage unit 150 may store events and information about the events in various ways. For example, the event information storage unit 150 may accumulatively store only events that have occurred from the present time t0 until a past preset time t1 or accumulatively store events that have occurred from the present time t0 until a past preset time t2 determined based on an unprocessed event D1. The event information storage unit 150 deletes an event D2 that passes a valid time for storage.

FIG. 7 illustrates a form of invoking an event stored in the event information storage unit 150.

As shown in FIG. 7, the event information storage unit 150 stores events based on a present time to. Here, the stored events may include an event allocated priority in processing. The rule based processing unit 140 refers to a logical state of an event in invoking the event from the event information storage unit 150 and invokes an event according to priority of the event.

For example, suppose that three events D3, D4 and D5 have priority and are stored chronologically in the event information storage unit 150 in order of D5, D4 and D3. In this case, the events D3, D4 and D5 are invoked by priority over other events. Here, if there is no defined order among D3, D4 and D5, the events are invoked in order of D5, D4 and D3 as stored chronologically.

Here, if D4 has priority over D3 and D5, D4 is invoked first among D3, D4 and D5.

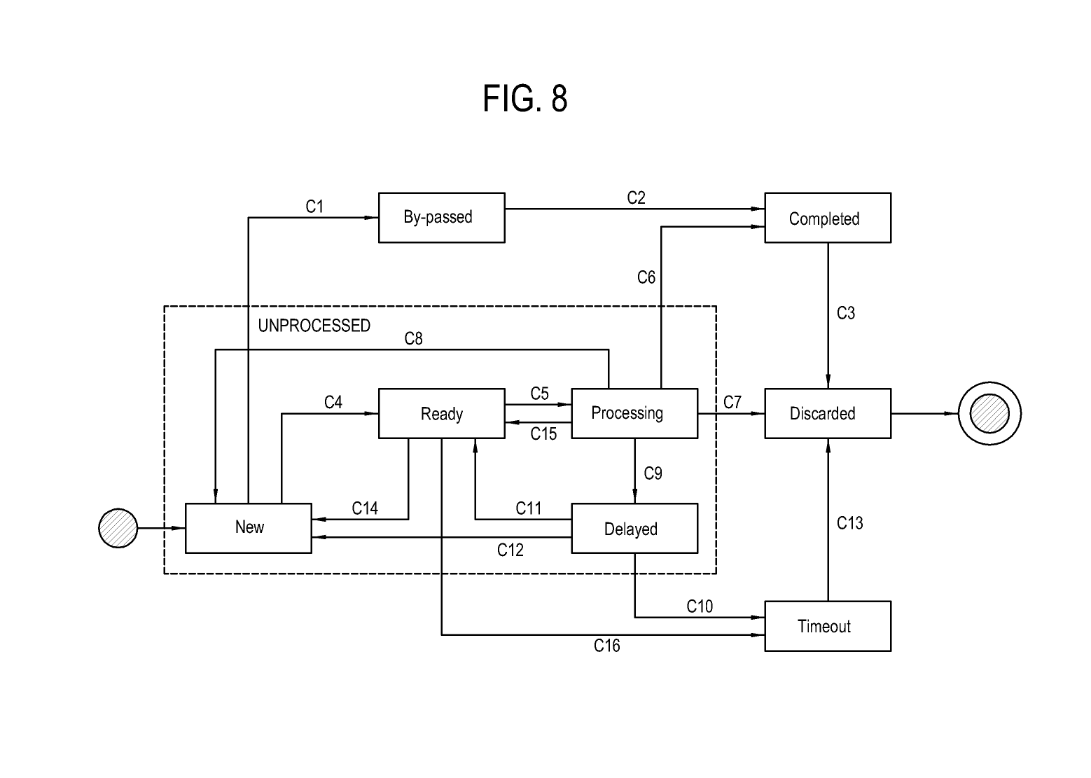

FIG. 8 illustrates a process that the rule based processing unit 140 changes a logical processing state of an event.

As shown in FIG. 8, in a process of invoking and processing an event, components involved in processing the event including the rule based processing unit 140 process the event with reference to a logical state of the event and update the logical state of the event by reflecting a processing result. It should be noted that a change in the logical state shown in FIG. 8 is provided for illustrative purposed only, and various modifications and alternatives may be employed in designing the information processing apparatus 1.

The logical state of the event may include, for example, ““New,” “Ready” “Processing,” “Delayed,” “By-passed,” “Completed,” “Timeout” and “Discarded,” wherein “New,” “Ready,” “Processing” and “Delayed” represent that the event is not yet processed.

When the event is detected at first by the event detection unit 110, the event is in a “New” state. When the rule processing determination unit 130 determines not to process the event based on a rule, the event is rendered from “New” to “By-passed” (C1).

When the final event transfer unit 170 transfers the “By-passed” event to the final event handler 180 to be processed, the event is rendered from “By-passed” to “Completed” (C2). The event processed by the final event handler 180 is rendered from “Completed” to “Discarded” and terminates (C3) when the event passes a storage time limit in the information processing apparatus 1.

When it is determined that the “New” event is processed based on the rule, the event is stored in the event information storage unit 150 and is rendered “Ready” (C4). The event, which is invoked and processed by the rule based processing unit 140, is rendered from “Ready” to “Processing” (C5). When the event completely processed based on the rule needs further storing, the event is rendered “Completed” and stored in the event information storage unit 150 (C6). When the event does not need further storing, the event is rendered “Discarded” (C7).

When the event is integrated with a different event into a new event based on determination of integrative processing with the different event, the event is rendered from “Processing” to “New” (C8). When the event needs to stand by for a particular condition, the event is “Delayed” (C9).

The “Delayed” event is rendered “Timeout” (C10) when the event passes a timeout period. Also, the “Delayed” event is rendered “Ready” (C11) when a standby condition of the event is satisfied. In addition, the “Delayed” event is rendered “New” (C12) when the event is integrated with a different event into a new event based on determination of integrative processing during rule processing with the different event.

The “Timeout” event is rendered “Discarded” (C13) when the event passes the storage time limit in the information processing apparatus 1. The “Ready” event is rendered “New” (C14) when the event is integrated with a different event into a new event based on determination of integrative processing during rule processing with the different event.

The “Processing” event is rendered “Ready” and stored in the event information storage unit 150 (C15) when the event needs to stand by for various reasons, for example, preoccupancy of a different event having a higher priority over the event. The “Ready” event is rendered “Timeout” (C16) when the event passes a predefined timeout period.

The rule based processing unit 140 may determine whether to invoke or exclude the event based on a particular logical state of the event when invoking the event from the event information storage unit 150. For example, the rule based processing unit 140 may invoke only the event in the “Ready” state from the event information storage unit 150.

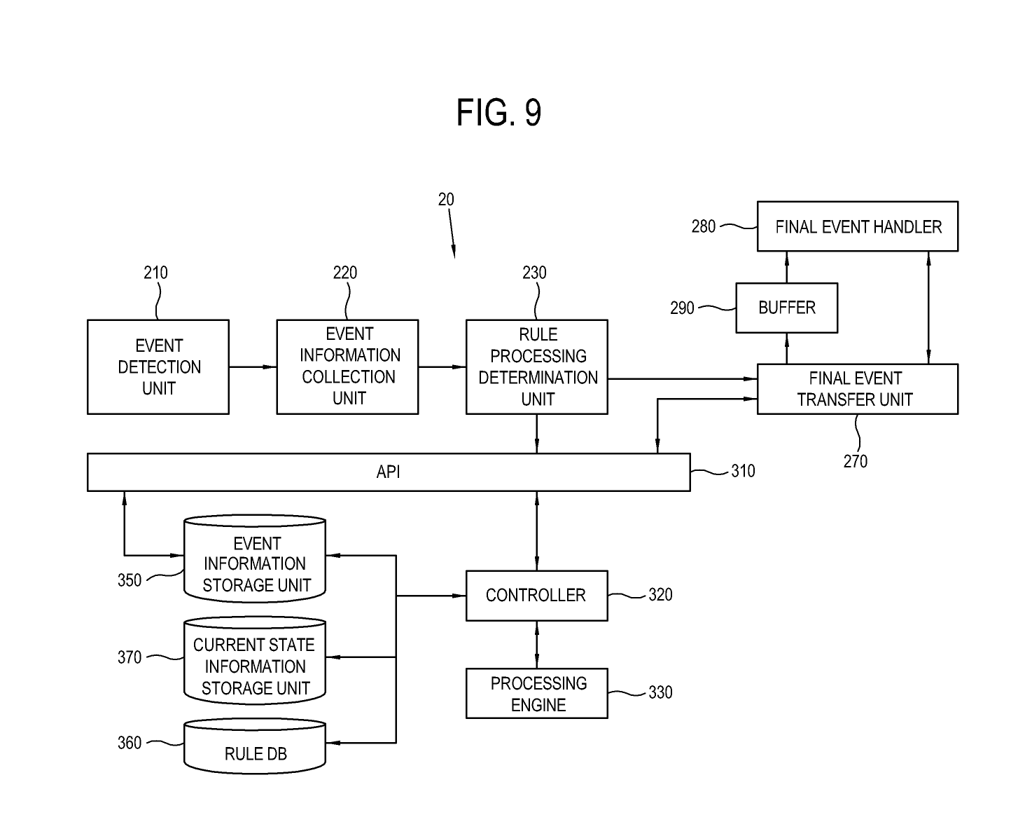

Hereinafter, a configuration for performing an action corresponding to an event according to a second exemplary embodiment will be described with reference to FIG. 9.

FIG. 9 is a diagram illustrating a configuration of a signal processing unit 20 to perform an action corresponding to an event according to the second exemplary embodiment.

As shown in FIG. 9, the signal processing unit 20 includes subcomponents, such as an event detection unit 210, a rule processing determination unit 230, a final event transfer unit 270, a final event handler 280, a buffer 290, an application programming interface (API) 310, a controller 320, a processing engine 330, an event information storage unit 350, a rule DB 360 and a current state information storage unit 370.

Here, the event detection unit 210, the rule processing determination unit 230, the final event transfer unit 270, the final event handler 380, the event information storage unit 350 and the rule DB 360 perform substantially the same functions as those in the first embodiment.

The API 310, the controller 320 and the processing engine 330 correspond to subdivisions of the rule based processing unit 140 of the first embodiment.

The API 310 serves as an interface in transmitting events, information and data between the rule processing determination unit 230, the final event transfer unit 270, the controller 320, the event information storage unit 350, the current state information storage unit 370 and the rule DB 360. The processing engine 330 performs a rule based process on an event according to control of the controller 320. The controller 320 controls operations of the processing engine 330 and the API 310 and performs reading, writing and updating with respect to the event information storage unit 350, the current state information storage unit 370 and the rule DB 360.

Updating or recording in the rule DB 360 may be enabled by accessing the rule DB 360 through the API 310.

The current state information storage unit 370 stores a user input configuration to the information processing apparatus 1, that is category information about the user input unit 40, and information about the final event handler 280. Such information may be also recorded and updated by accessing the current state information storage unit 370 through the API 310. The information stored in the current state information storage unit 370 may be used for reference for optimizing a rule based process of an event.

The category information about the user input unit 40 may include a kind of the user input unit 40, for example, a remote controller and a keyboard, a model name of the user input unit 40, a version number of the user input unit 40 and unique identification information about the user input unit 40.

The information about the final event handler 280 may include a version number of the final event handler 280 when created, category information about a supported input event including an event type supportable by the final event handler 280 and a model name or version of a supported device, or unique identification information about the final event handler 280.

For example, suppose that a user says “What is this?” indicating a particular location on the information processing apparatus 1 with a finger.

First, the event detection unit 210 detects a gesture event resulting from a gesture with the user's finger. The event information collection unit 220 collects information about the gesture event, e.g., time at which the gesture event occurs and the location indicated by the user in the gesture event. The rule processing determination unit 230 transmits the gesture event to the API 310 to process the gesture event based on a rule. The API 310 stores the gesture event in the event information storage unit 350.

Secondarily, the event detection unit 210 detects a speech event resulting from the user speaking. The event information collection unit 220 collects information about the speech event, e.g., time at which the speech event occurs and details of a voice instruction spoken by the user in the speech event. The rule processing determination unit 230 transmits the speech event to the API 310 to process the speech event based on a rule. The API 310 stores the speech event in the event information storage unit 350.

The controller 320 invokes a voice event and information collected about the voice event from the event information storage unit 350.

The controller 320 selects a rule from the rule DB 360 based on the collected information and transmit the rule to the processing engine 330 for processing the voice event. The processing engine 330 processes the voice event based on the transmitted rule.

The processing engine 330 recognizes that the voice event corresponds to the event of saying “What is this?” during the rule process and requests that the controller 320 retrieve the gesture event. The controller 320 retrieves the gesture event and the collected information about the gesture event from the event information storage unit 350 and transmit the gesture event and the collected information to the processing engine 330. The processing engine 330 combines the voice event and the gesture event into one integrated event.

The controller 320 transmits the integrated event, obtained by combining the voice event and the gesture event, to the final event transfer unit 270 through the API 310, and transmits the integrated event to the event information storage unit 350 if it is determined that the mixed event is needed for subsequent events.

The final event transfer unit 270 transmits the integrated event to the buffer 290, and the integrated event is processed by the final event handler 280 according to processing order of a plurality of events that stands by in the buffer 290. Alternatively, the final event transfer unit 270 may instantly invoke the final event handler 280 to process the integrated event.

The final event handler 280 processes the transmitted integrated event and provides a processing result to the user. For example, the final event handler 280 may provide a description of what an image displayed in the location indicated by the user.

The final event handler 280 may need additional information about the event in processing the event. Here, the final event handler 280 may request the additional information to the final event transfer unit 270, and the final transfer unit 270 may transmit this request to the API 310.

The controller 320 invokes event information needed for the final event handler 280 from the event information storage unit 350, the current state information storage unit 370 and the rule DB 360 and transmits the event information to the final event transfer unit 270. The final event transfer unit 270 transmits the event information to the final event handler 280.

Meanwhile, event information collected by the event information collection unit 220 may include various kinds of items.

Event information collected may include an event ID that is a unique identification of an event, an event source that is a unique identification of the user input unit 40 that generates an event, and an event kind to define a type of an event.

Further, additional event information may include information as follows.

Final event transfer reference information is used for reference to determine a final event handler 280 to which a particular event is transferred, for example, priority of each final event handler 280. Time information may include a period from an event start time to an event end time and a period from a time at which interpretation of an event starts to a time at which interpretation of the event ends. Input reliability information is used to calculate reliability of whether an event actually reflects a user intent, for example, accuracy of a voice instruction. Priority information is information on importance and urgency of an event. User information is an ID of a user who uses the user input unit 40. Special information by each user input unit 40 is specialized information, such as a face direction or an expression on a face in face recognition, a position or speed of a user's body part in gesture recognition, and volume or intonation of a voice in voice recognition.

Meanwhile, additional information for event processing, which the controller 320 and the processing engine 330 use in a rule based process, may include a timeout as valid time for successful event processing, a logical state of an event to indicate a current processing status of the event, a rule implementation state that is needed to determine a rule to implement first so as to process an event, and a standby relationship to indicate a state that a particular event is waiting for a different event.

Further, information transmitted by the final event transfer unit 270 to the final event handler 280 may include an event ID to identify an event, an event category to define an event type, and arrangement information to dispose events according to time or priority in use of the buffer 290.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An information processing apparatus comprising:
an event detector configured to detect an occurrence of an event;
an event information collector configured to collect information about the event detected by the event detector;
a rule database configured to store at least one rule that defines a condition and a process to be performed when the condition is satisfied;
a rule based processor configured to select at least one rule from the rule database based on at least part of the information collected by the event information collector, and to perform a rule based process of processing the event based on the selected at least one rule; and
a final event transferor configured to transfer the processed event to a predetermined final event handler.

2. The information processing apparatus of claim 1, wherein the rule based processor is configured to select at least one of the at least one rule from the rule database that defines a condition corresponding to at least part of the information collected about the event.

3. The information processing apparatus of claim 1, wherein the information about the event collected by the event information collector comprises a kind of the event.

4. The information processing apparatus of claim 1, further comprising an event information storage configured to store the event and the information about the event, wherein the rule based processor invokes and processes the event stored in the event information storage according to a preset order.

5. The information processing apparatus of claim 4, wherein the preset order is the order in which a plurality of events is stored in the event information storage.

6. The information processing apparatus of claim 4, wherein the events are allocated corresponding priorities based on the corresponding information collected about the events, and
wherein the preset order corresponds to the priorities.

7. The information processing apparatus of claim 1, further comprising a rule processing decider configured to determine whether to transmit the event detected by the event detector to the rule based processor or to bypass the rule based processor, by transmitting the event to the final event transferor.

8. The information processing apparatus of claim 7, wherein the rule processing decider determines a transfer direction of the event based on at least part of the information about the event collected by the event information collector.

9. The information processing apparatus of claim 1, wherein the final event handler comprises an application implemented on an operating system of the information processing apparatus.

10. The information processing apparatus of claim 1, further comprising at least one user input apparatus configured to receive user input, wherein the event detector detects the event of receiving user input through the at least one user input apparatus.

11. A control method of an information processing apparatus, the control method comprising:
detecting an occurrence of an event;
collecting information about the event;
selecting at least one rule from a rule database based on at least part of the information collected about the event, the rule database storing the at least one rule that defines a condition and at least one process to be performed when the condition is satisfied;
performing a rule based process of processing the event based on the selected rule; and
transferring the processed event to a predetermined final event handler.

12. The control method of claim 11, wherein the selecting of the at least one rule from the rule database comprises selecting the at least one rule that defines a condition that corresponds to at least part of the information collected about the event.

13. The control method of claim 11, wherein the information collected about the event comprises at least a kind of the event.

14. The control method of claim 11 further comprising:
before the selecting step, determining whether or not to perform the selecting and performing steps.

15. The control method of claim 14, wherein the determining step comprises determining a transfer direction of the event based on the information collected about the event.

16. The control method of claim 11, wherein the final event handler comprises an application implemented on an operating system of the information processing apparatus.

17. The control method of claim 11, wherein the event occurs by a user manipulation.

18. The information processing apparatus of claim 7, wherein the rule processing decider determines whether to transmit the event detected by the event detector to the rule based processor or to bypass the rule based processor based on a preset condition.

19. The information processing apparatus of claim 1, further comprising a rule processing decider configured to determine whether to transmit the event detected by the event detector to the rule based processor so as to perform the rule based process or to bypass the rule based processor, so as not to perform the rule based process, by transmitting the event to the final event transferor.

20. The information processing apparatus of claim 1 wherein the defined condition corresponds to a state of the information processing apparatus.

21. The control method of claim 14, wherein the determining step comprises determining whether or not to perform the selecting and performing steps based on a preset condition.

22. The control method of claim 21, wherein the determining step further comprises determining a transfer direction of the event based on the information collected about the event.
